(19) United States
(12) Patent Application Publication
(10) Pub. No.: US 2005/0064103 A1
(43) Pub. Date: Mar. 24, 2005

(54) Method for forming periodic electronic potential structures in bulk solids using standing electromagnetic waves

(76) Inventor: Nathan David Hiller, San Diego, CA (US)

Correspondence Address: Nathan David Hiller, #215, 4750 Noyes St., San Diego, CA, 92109, US

(21) Appl. No.: 10/669,449

(22) Filed: Sep. 23, 2003

(51) Int. Cl. B05D 3/00

(52) U.S. Cl. 427/444; 427/457

(57) ABSTRACT

A method for forming periodic electronic potential structures in doped bulk solids using one or more standing electromagnetic waves is disclosed. Using a single standing electromagnetic wave (47) a monocrystal silicon sample uniformly doped with Li⁷ atoms (21) is converted into a monocrystal silicon sample containing planes of Li⁷ atoms (57). Using two and three standing electromagnetic waves, oriented perpendicular to one another, a monocrystal silicon sample containing rows or wires of Li⁷ atoms (108), and a monocrystal silicon sample containing dots, spots, or clusters of Li⁷ atoms (112) can be formed, respectively.

### CROSS-REFERENCE TO RELATED APPLICATIONS

This application claims the benefit of Disclosure Documents 529406, 531741, 532668, and 537991.

### BACKGROUND

1. Field of Invention

This invention relates to methods for forming periodic electronic potential structures, specifically to periodic electronic potential structures arising from graded dopant or impurity composition such as some forms of multi-layered thin and thick films, wire arrays, dot arrays, quantum well arrays, quantum wire arrays, and quantum dot arrays.

2. Description of Prior Art

Multi-layered thin and thick films, wire arrays, dot arrays, quantum well arrays, quantum wire arrays, and quantum dot arrays are periodic electronic potential structures that have a variety of unique electronic, magnetic, optical, and thermal properties. The major problem with the methods used to form these electronic potential structures in solid form is that each method forms the potential structures using a layer-by-layer approach, which by its nature is slow.

Multi-layered thin and thick films and multiple quantum wells are formed “layer-by-layer” using one of many techniques such as molecular beam epitaxy (MBE) U.S. Pat. No. 3,751,310 to Chu (1973), chemical vapor deposition (CVD) U.S. Pat. No. 4,107,352 to Hakim (1978), plasma-enhanced chemical vapor deposition (PECVD) U.S. Pat. No. 4,557,943 to Rosler (1985), metal-organic chemical vapor deposition (MOCVD) U.S. Pat. No. 4,895,737 to Griffiths (1990), Sputtering (S) U.S. Pat. No. 4,415,427 to Hidler (1983), and pulsed laser deposition (PLD) U.S. Pat. No. 6,312,768 to Rode (2001). In these methods all of the film layers cannot be formed simultaneously because each film layer provides the structural support for the next film layer. Thus, only one thin film layer can be formed at a time. To produce a bulk solid sample of multi-layered thin or thick films or multiple quantum wells using these layer-by-layer methods requires long fabrication times and expensive equipment.

Wire arrays and quantum wire arrays can be formed by the self-alignment of a thin layer of atoms or molecules into grooves on the surface of a substrate, U.S. Pat. No. 6,242,275 to Kim (2001). To produce a bulk solid sample of wire arrays or quantum wire arrays using this layer-by-layer method requires long fabrication times and expensive equipment.

Dot arrays and quantum dot arrays can be formed by depositing a thin layer of material A onto the surface of a substrate made of material B, in which there exists a significant difference between the lattice constants of material A and material B. To minimize the strain caused by this mismatch in lattice constants, the thin layer of atoms from material A spontaneously self-assembles into quantum dots on the substrate surface, U.S. Pat. No. 6,313,479 to Zhang (2001). To produce a bulk solid sample of dot arrays or quantum dot arrays using this layer-by-layer method requires long fabrication times, and expensive equipment. Also, using this layer-by-layer approach it is difficult to obtain identical dot structures and consistent dot spacing.

Standing electromagnetic waves have been used to change the chemical composition in solids in a periodic fashion through chemical reactions, however they have never been used to change the chemical composition in solids in a periodic fashion by varying the dopant or impurity density. In U.S. Pat. No. 4,403,827 to Bryan (1983) a standing electromagnetic wave is used to chemically change photoresist in a periodic fashion resulting in a diffraction grating. In U.S. Pat. No. 5,438,011 to Blalock (1995) a standing electromagnetic wave is used to chemically change photoresist in a periodic fashion to form capacitors. In U.S. Pat. No. H1,911 to Land (2000) a standing electromagnetic wave is used to cure optical material in a plane optical resonant cavity. In U.S. Pat. No. 4,032,341 to Momose (1977) a standing electromagnetic wave is used to expose photosensitive material.

### OBJECTS AND ADVANTAGES

Accordingly, several objects and advantages of my invention are:
a) to provide a method for forming a multitude of thin or thick films, or wire arrays, or dot arrays, or quantum well arrays, or quantum wire arrays, or quantum dot arrays in a bulk solid simultaneously;
b) to provide a method for forming a multitude of thin or thick films, or wire arrays, or dot arrays, or quantum well arrays, or quantum wire arrays, or quantum dot arrays in a bulk solid with identical structures and consistent spacing.

Another object and advantage is to provide a method for forming electronic potential structures, which can later be altered and/or easily recycled. Still further objects and advantages of my invention will become apparent from a consideration of the ensuing description and drawings.

### DRAWING FIGURES

In the drawings, closely related figures and parts have the same number but different alphabetical suffixes.

FIGS. 1A to 1B show a monocrystal silicon sample uniformly doped with Li⁷ atoms, and a associated energy band diagram.

FIGS. 2A to 2C show the process of converting the monocrystal silicon sample uniformly doped with Li⁷ atoms to a monocrystal silicon sample containing planes of Li⁷ atoms using a standing electromagnetic wave.

FIG. 3 shows a periodic well-shaped energy band diagram associated with the monocrystal silicon sample containing planes of Li⁷ atoms shown in FIG. 2C.

FIG. 4 shows the monocrystal silicon sample uniformly doped with Li⁷ atoms in the path of the standing electromagnetic wave, which is created by the splitting, and crossing of the electromagnetic wave inside a vacuum chamber.

FIG. 5A to 5C show the process of converting the monocrystal silicon sample uniformly doped with Li⁷ atoms to a monocrystal silicon sample containing rows of Li⁷ atoms and a monocrystal silicon sample containing dots, spots, or clusters of Li⁷ atoms using more than one standing electromagnetic wave.

### REFERENCE NUMERALS IN DRAWINGS

20 monocrystal silicon sample
21 monocrystal silicon sample uniformly doped with Li⁷ atoms
22 Li⁷ atom
24 conduction energy band edge
26 fermi energy level
28 intrinsic energy level
29 valence energy band edge
32 energy band diagram
35 periodic well-shaped energy band diagram
43 arrow
44a electromagnetic wave
44b electromagnetic wave
44c electromagnetic wave
44d electromagnetic wave
44z electromagnetic wave
45 sample thickness
47 standing electromagnetic wave
48 plane of standing electromagnetic wave electric field nodes
50 plane of standing electromagnetic wave electric field anti-nodes
52 points of peak electric field intensity
54 points of minimum electric field intensity
56 distance between two neighboring planes containing a high density of Li⁷ atoms
57 monocrystal silicon sample containing planes of Li⁷ atoms
59 plane containing a high density of Li⁷ atoms
60 plane containing a low density of Li⁷ atoms
61 well-shaped region containing a high density of conduction electrons
76 quantum cascade laser
78 variable actuator
80 spatial light filter
82 convex lens
84 iris
86 beam splitter
88 reflector
92 support fixture
96 vacuum chamber
98 vacuum pump
100 plane of standing electromagnetic wave electric field nodes
102 standing electromagnetic wave
104 region containing a low density of Li⁷ atoms
106 row or wire containing a high density of Li⁷ atoms
108 monocrystal silicon sample containing rows or wires of Li⁷ atoms
110 dot, spot, or cluster containing a high density of Li⁷ atoms
112 monocrystal silicon sample containing dots, spots, or clusters of Li⁷ atoms

### SUMMARY

In accordance with the present invention a method for forming periodic electronic potential structures in bulk solids using a standing electromagnetic wave. The periodic electronic potential structures formed are a result of periodically graded dopant or impurity composition within the bulk solid. This periodically graded dopant or impurity composition is formed from a uniform dopant composition using a standing electromagnetic wave.

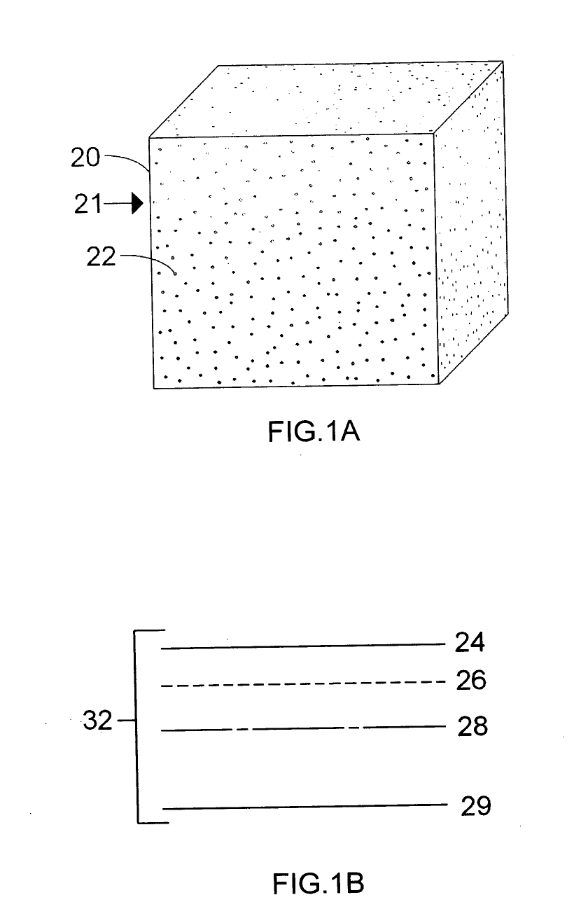

### DESCRIPTION—FIGS. 1 to 5

FIGS. 1A to 1B show the monocrystal silicon sample uniformly doped with Li⁷ atoms 21, and the associated energy band diagram 32. In FIG. 1A a Li⁷ atom 22 density of 10¹⁴ Li⁷ atoms per cm³ exists uniformly in a monocrystal silicon sample 20. The temperature of the monocrystal silicon sample uniformly doped with Li⁷ atoms 21 is 300° K. FIG. 1B shows the energy band diagram 32 for the monocrystal silicon sample uniformly doped with Li⁷ atoms 21, which consists of a conduction energy band edge 24, a fermi energy level 26, a intrinsic energy level 28, and a valence energy band edge 29, listed in the order of decreasing energy. The fermi energy level 26 is at a higher energy than the intrinsic energy level 28 because the dopant Li⁷ atoms 22 are electron donors in silicon. The energy band diagram 32 in FIG. 1B is a constant or flat electronic potential structure. The monocrystal silicon sample uniformly doped with Li⁷ atoms 21 is a bulk solid. The Li⁷ atom 22 is defined as the dopant or impurity.

In FIG. 1A increasing the density of Li⁷ atoms 22 in the monocrystal silicon sample 20 results in increasing the energy difference between the fermi energy level 26 and the intrinsic energy level 28 in FIG. 1B. Decreasing the density of Li⁷ atoms 22 in the monocrystal silicon sample 20 results in decreasing the energy difference between the fermi energy level 26 and the intrinsic energy level 28 in FIG. 1B.

In FIG. 1B the greater the energy difference between the fermi energy level 26 and the intrinsic energy level 28, the greater the density of conduction electrons in the monocrystal silicon sample uniformly doped with Li⁷ atoms 21 of FIG. 1A. In FIG. 1B the lesser the energy difference between the fermi energy level 26 and the intrinsic energy level 28, the lesser the density of conduction electrons in the monocrystal silicon sample uniformly doped with Li⁷ atoms 21 of FIG. 1A.

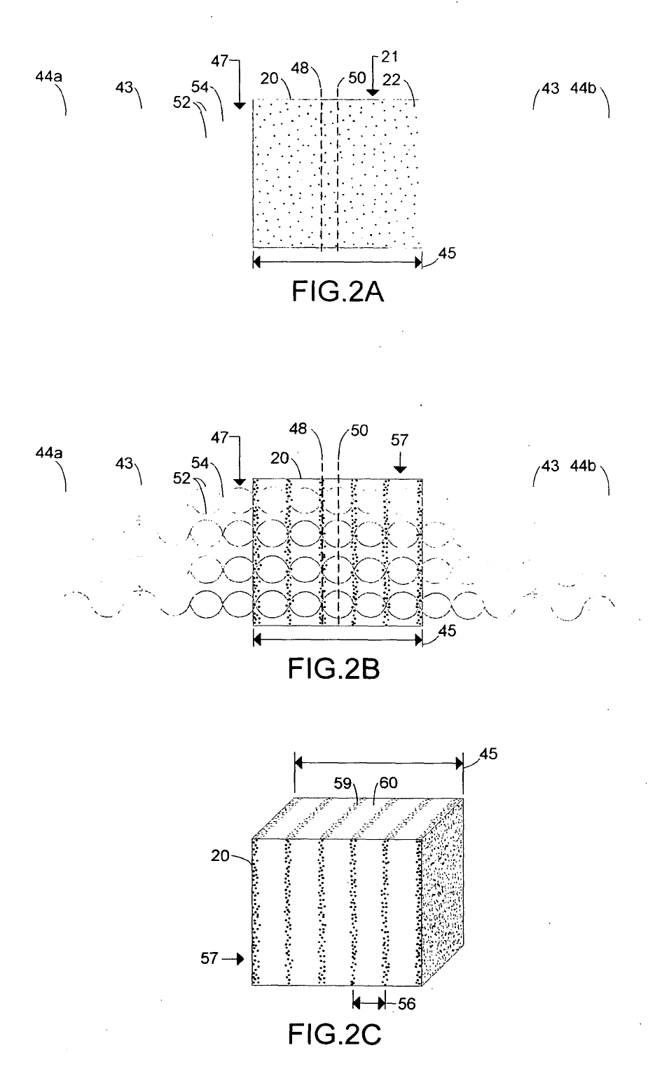

FIGS. 2A to 2C show the process of converting the monocrystal silicon sample uniformly doped with Li⁷ atoms 21 to the monocrystal silicon sample containing planes of Li⁷ atoms 57 using the standing electromagnetic wave 47. The monocrystal silicon sample uniformly doped with Li⁷ atoms 21 and the monocrystal silicon sample containing planes of Li⁷ atoms 57 are much thinner than they appear in FIGS. 2A to 2C. Their sizes are deliberately distorted to clarify the internal physics underlying my method for forming periodic electronic potential structures in bulk solids using standing electromagnetic waves. In FIG. 2A the monocrystal silicon sample uniformly doped with Li⁷ atoms 21 is a 15.24 cm (6 inch) diameter wafer with a sample thickness 45 of 1 mm. This wafer is sawed from a 15.24 cm (6 inch) diameter silicon single crystal ingot doped with 10¹⁴ Li⁷ atoms per cm³. The saw used is a diamond-tipped inner-hole blade saw. The sample is mechanically lapped and ground on both sides to obtain a flat surface. To give the wafer a mirror like finish it is polished using a slurry of fine SiO₂ particles in basic NaOH solution. In FIG. 2B the monocrystal silicon sample containing planes of Li⁷ atoms 57 has the same dimensions as the 15.24 cm (6 inch) diameter wafer with sample thickness 45 of 1 mm. In FIG. 2C the monocrystal silicon sample containing planes of Li⁷ atoms 57 is a square-sheet-shaped wafer with dimensions 5.08 cm by 5.08 cm (2 inch by 2 inch) with a sample thickness 45 of 1 mm. The temperature of the monocrystal silicon sample uniformly doped with Li⁷ atoms 21 is 300° K in FIG. 2A. The temperature of the monocrystal silicon sample containing planes of Li⁷ atoms 57 is 300° K in FIG. 2B and 170° K in FIG. 2C.

In FIGS. 2A and 2B a standing electromagnetic wave 47 is established inside the monocrystal silicon sample 20 by overlapping a electromagnetic wave 44a and a electromagnetic wave 44b, which are propagating parallel to one another in opposite directions inside the monocrystal silicon sample 20. An arrow 43 indicates the direction in which each electromagnetic wave is propagating. The frequency of both electromagnetic waves is 1.56×10¹³ Hz. The electromagnetic waves propagate in a straight line but are shown as a wavy or rippled lines to illustrate their wave nature. The standing electromagnetic wave 47 has time varying points of a peak electric field intensity 52 which are defined as anti-nodes and time varying points of a minimum electric field intensity 54 which are defined here as nodes. The points of peak electric field intensity 52 lie in a plane of standing electromagnetic wave electric field antinodes 50 and the points of minimum electric field intensity 54 lie in a plane of standing electromagnetic wave electric field nodes 48. Due to the non-zero absorption coefficient of 1.5 cm⁻¹ for the electromagnetic wave in the monocrystal silicon sample 20 at 300° K, each electromagnetic wave intensity is reduced by 14% after propagating the distance of the sample thickness 45. This reduction in the electromagnetic waves intensities result in a decrease in the standing electromagnetic wave 47 quality with increasing distance from the center of the monocrystal silicon sample 20.

In FIGS. 2A and 2B both electromagnetic waves are coherent and originate from the same constant wave source, which is a 60 milliwatt tunable far infrared quantum cascade laser (Bell Labs, Murray Hill, N.J.) tuned to the frequency 1.56×10¹³ Hz. The beam diameter of the electromagnetic waves and standing electromagnetic wave 47 is 10.16 cm (4 inches). The surfaces in which the electromagnetic waves enter and exit the monocrystal silicon sample 20 are flat and parallel to one another. The standing electromagnetic wave 47 beam is concentric or centered to the monocrystal silicon sample 20.

The process of converting the monocrystal silicon sample uniformly doped with Li⁷ atoms 21 to the monocrystal silicon sample containing planes of Li⁷ atoms 57 using the standing electromagnetic wave 47, as illustrated in FIGS. 2A to 2C, can be explained by the position dependent diffusion enhancement of the Li⁷ atoms 22. The frequency of the electromagnetic waves is the same as the local vibration mode frequency of the Li⁷ atom 22 in the monocrystal silicon sample 20. This local vibration mode frequency is 1.56×10¹³ Hz. When the Li⁷ atom 22 absorbs a photon from the standing electromagnetic wave 47 the Li⁷ atom 22 dissipates the photon's energy to surrounding local silicon atoms via one or more phonons. The net effect is that the Li⁷ atom 22 and the surrounding local silicon atoms will have a temporary increase in kinetic energy. This temporary increase in kinetic energy of the Li⁷ atom 22 and the surrounding local silicon atoms will increase the probability of the Li⁷ atom 22 jumping to a neighboring lattice site within the monocrystal silicon sample 20. In other words, the temporary increase in kinetic energy of the Li⁷ atom 22 and the surrounding local silicon atoms results in an increase in the rate of migration or diffusion of the Li⁷ atom 22 in the monocrystal silicon sample 20. A Li⁷ atom 22 has the highest probability of absorbing a photon from the standing electromagnetic wave 47 in the plane of standing electromagnetic wave electric field antinodes 50. A Li⁷ atom 22 has the lowest probability of absorbing a photon from the standing electromagnetic wave 47 in the plane of standing electromagnetic wave electric field nodes 48. After applying the standing electromagnetic wave 47 to the monocrystal silicon sample uniformly doped with Li⁷ atoms 21 for 30 days, the density of Li⁷ atoms 22 in the plane of standing electromagnetic wave electric field nodes 48 increases significantly above 10¹⁴ Li⁷ atoms per cm³. The density of Li⁷ atoms 22 in the plane of standing electromagnetic wave electric field anti-nodes 50 decreases significantly below 10¹⁴ Li⁷ atoms per cm³. As a result, a plane containing a high density of Li⁷ atoms 59 and a plane containing a low density of Li⁷ atoms 60 is formed simultaneously in an alternating fashion and parallel to one another within the monocrystal silicon sample 20 as shown in FIG. 2C. A multitude of planes containing a high density of Li⁷ atoms 59 and planes containing a low density of Li⁷ atoms 60 is formed simultaneously in an alternating fashion and parallel to one another within the monocrystal silicon sample 20 as shown in FIG. 2C. The term high in this case is defined as greater than 10¹⁴ Li⁷ atoms per cm³ and the term low in this case is defined as less than 10¹⁴ Li⁷ atoms per cm³. A distance between two neighboring planes containing a high density of Li⁷ atoms 56 is 2.82×10⁻⁶ meters as shown in FIG. 2C. The boundary between a given plane containing a high density of Li⁷ atoms 59 and a neighboring plane containing a low density of Li⁷ atoms 60 is graded in Li⁷ atom 22 density rather than discontinuous in a step like fashion. The final monocrystal silicon sample containing planes of Li⁷ atoms 57 is shown in FIG. 2C after being cut from a 15.24 cm (6 inch) diameter wafer of sample thickness 45 of 1 mm into a 5.08 cm by 5.08 cm (2 inch by 2 inch) square-shaped wafer of sample thickness 45 of 1 mm

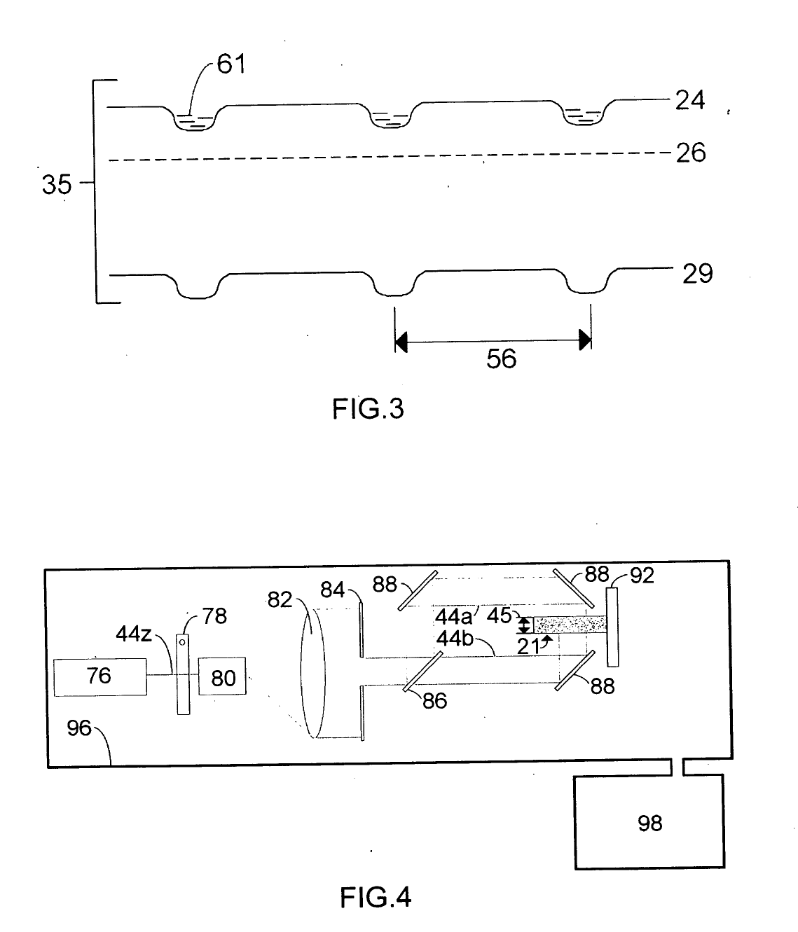

FIG. 3 shows the periodic well-shaped energy band diagram 35 associated with the monocrystal silicon sample containing planes of Li⁷ atoms 57 shown in FIG. 2C. A well-shaped region containing a high density of conduction electrons 61 exists near the conduction energy band edge 24. These well-shaped regions containing a high density of conduction electrons 61 exist because of the planes containing a high density of Li⁷ atoms 59 in the monocrystal silicon sample 20 shown in FIG. 2C. For each plane containing a high density of Li⁷ atoms 59 in the monocrystal silicon sample 20 shown in FIG. 2C, there exists a corresponding well-shaped region containing a high density of conduction electrons 61 in the energy band diagram shown in FIG. 3. The distance between two neighboring well-shaped regions containing a high density of conduction electrons 61 is the same as the distance between two neighboring planes containing a high density of Li⁷ atoms 56 shown in FIG. 2C. The periodic well-shaped energy band diagram 35 in FIG. 3 is a periodic electronic potential structure.

The equipment used to create the standing electromagnetic waves shown in FIGS. 2A and 2B is shown in FIG. 4. The monocrystal silicon sample uniformly doped with Li⁷ atoms 21 and the electromagnetic waves 44a and 44b of FIG. 2A are shown inside the vacuum chamber 96 in FIG. 4. FIG. 4 shows the monocrystal silicon sample uniformly doped with Li⁷ atoms 21 in the path of a standing electromagnetic wave, which is created by the splitting, and crossing of a electromagnetic wave 44z inside the vacuum chamber 96. Inside the vacuum chamber 96 a quantum cascade laser 76 creates the electromagnetic wave 44z, which propagates through a variable actuator 78 and a spatial light filter 80. The quantum cascade laser 76 is a coherent, constant wave source tuned to the frequency 1.56×10¹³ Hz with a power output of 60 milliwatts. The electromagnetic wave 44z then diverges into a convex lens 82 and is then reduced to a 10.16 cm (4 inch) beam diameter by a iris 84. The electromagnetic wave 44z is then split into two electromagnetic waves 44a and 44b, perpendicular to one another, by a beam splitter 86. Two electromagnetic waves 44a and 44b then reflect from a reflector 88 and intersect and overlap parallel to one another such that a standing electromagnetic wave forms within the monocrystal silicon sample uniformly doped with Li⁷ atoms 21 as described in FIG. 2A. A support fixture 92 holds the monocrystal silicon sample uniformly doped with Li⁷ atoms 21 in place while the standing electromagnetic wave forms the planes containing a high density of Li⁷ atoms 59 and planes containing a low density of Li⁷ atoms 60 inside of it as described in FIGS. 2A and 2B. To pump down and maintain a vacuum in the vacuum chamber 96 a vacuum pump 98 is connected to the vacuum chamber and is operated as needed. Vacuum is defined here as a gas pressure of less than or equal to 1 torr.

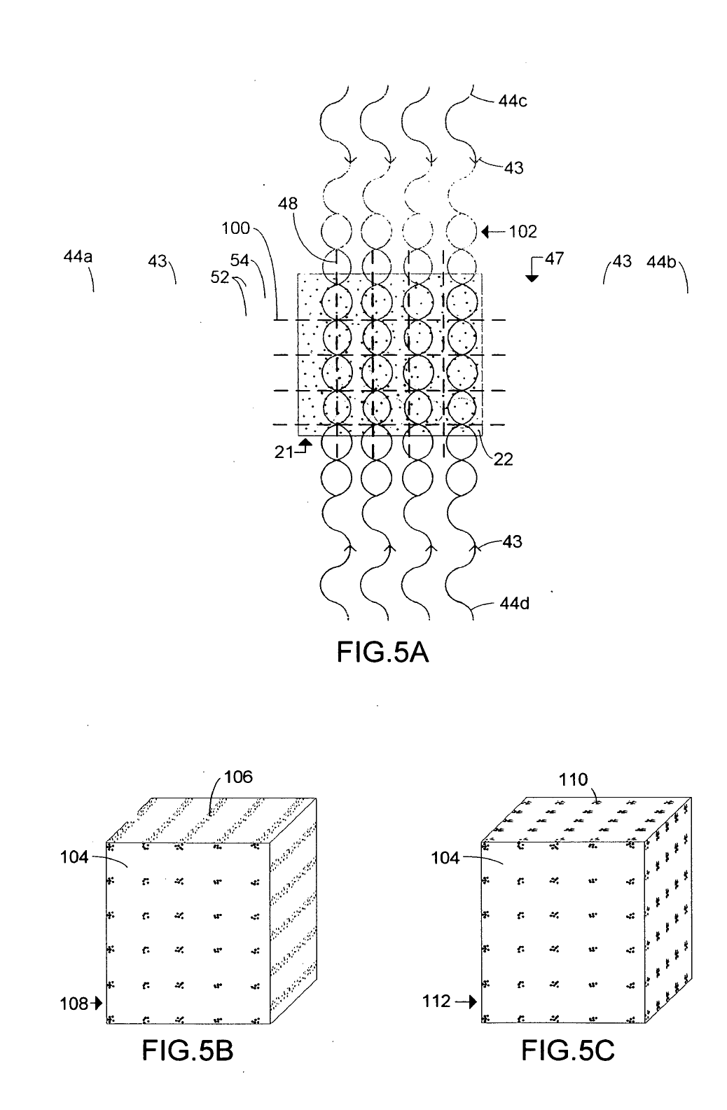

FIG. 5A shows the process of converting the monocrystal silicon sample uniformly doped with Li⁷ atoms 21 to the monocrystal silicon sample containing rows or wires of Li⁷ atoms 108 using the standing electromagnetic wave 47 and a standing electromagnetic wave 102. The monocrystal silicon sample uniformly doped with Li⁷ atoms 21 in FIG. 5A and the monocrystal silicon sample containing rows or wires of Li⁷ atoms 108 in FIG. 5B are cubes with dimensions 1 mm×1 mm×1 mm. This cube is cut from a 15.24 cm (6 inch) diameter silicon single crystal ingot doped with 10¹⁴ Li⁷ atoms per cm³. The saw used is a diamond-tipped inner-hole blade saw. The cube is mechanically lapped and ground on all of its faces to obtain flat surfaces. To give the cube a mirror like finish on all of its faces it is polished using a slurry of fine SiO₂ particles in basic NaOH solution. The temperature of the monocrystal silicon sample uniformly doped with Li⁷ atoms 21 is 300° K in FIG. 5A. The temperature of monocrystal silicon sample containing rows or wires of Li⁷ atoms 108 is 170° K in FIG. 5B.

In FIG. 5A the standing electromagnetic wave 47 is established inside the monocrystal silicon sample uniformly doped with Li⁷ atoms 21 by the overlapping of the electromagnetic wave 44a and a electromagnetic wave 44b, which are propagating parallel to one another in opposite directions. The second standing electromagnetic wave 102 is established inside the monocrystal silicon sample uniformly doped with Li⁷ atoms 21 by the overlapping of a electromagnetic wave 44c and a electromagnetic wave 44d, which are propagating parallel to one another in opposite directions. A arrow 43 indicates the direction in which each electromagnetic wave is propagating. The standing electromagnetic wave 47 is perpendicular to the standing electromagnetic wave 102. The planes of standing electromagnetic wave electric field nodes 48 is caused by the standing electromagnetic wave 47. A plane of standing electromagnetic wave electric field nodes 100 is caused by the standing electromagnetic wave 102. The frequency of all the electromagnetic waves is 1.56×10¹³ Hz. The electromagnetic waves propagate in a straight line but are shown as a wavy or rippled lines to illustrate their wave nature.

In FIG. 5A all the electromagnetic waves are coherent and originate from the same constant wave source, which is a 60 milliwatt tunable far infrared quantum cascade laser tuned to the frequency 1.56×10¹³ Hz. The beam diameter of the electromagnetic waves and standing electromagnetic waves is 2.54 cm (1 inch). The surfaces in which the electromagnetic waves enter and exit the monocrystal silicon sample uniformly doped with Li⁷ atoms 21 are flat. Each standing electromagnetic wave's beam is concentric or centered to the monocrystal silicon sample uniformly doped with Li⁷ atoms 21.

The process of converting the monocrystal silicon sample uniformly doped with Li⁷ atoms 21 to the monocrystal silicon sample containing rows or wires of Li⁷ atoms 108 using the standing electromagnetic waves 47 and 102, as illustrated in FIG. 5A, can be explained by the position dependence of the diffusion enhancement of the Li⁷ atoms as previously described in FIGS. 2A and 2B. However, due to the fact that two standing electromagnetic waves exist in FIG. 5A, it is the intersections of the planes of standing electromagnetic wave electric field nodes 48 and 100 that have the minimum electric field intensities. These intersections form lines in FIG. 5A, not planes as is the case in FIG. 2A and 2B. As a result, Li⁷ atoms 22 located at the intersections of the planes of standing electromagnetic wave electric field nodes 48 and 100 have the lowest probability of absorbing a photon from the standing electromagnetic waves. After applying the two standing electromagnetic waves to the monocrystal silicon sample uniformly doped with Li⁷ atoms 21 for 30 days, the density of Li⁷ atoms 22 in the intersections previously described, increase significantly above 10¹⁴ Li⁷ atoms per cm³. As a result, a row or wire containing a high density of Li⁷ atoms 106 and a region containing a low density of Li⁷ atoms 104 forms simultaneously in an array pattern as shown in FIG. 5B. The term high in this case is defined as greater than 10¹⁴ Li⁷ atoms per cm³ and the term low in this case is defined as less than 10¹⁴ Li⁷ atoms per cm³. The boundary between a given row or wire containing a high density of Li⁷ atoms 106 and its neighboring region containing a low density of Li⁷ atoms 104 is graded in Li⁷ atom 22 density rather than discontinuous in a step like fashion. The final monocrystal silicon sample containing rows or wires of Li⁷ atoms 108 and regions containing a low density of Li⁷ atoms 104 is shown in FIG. 5B.

If a third standing electromagnetic wave, oriented perpendicular to the other two standing electromagnetic waves 47 and 102, is applied to the monocrystal silicon sample uniformly doped with Li⁷ atoms 21 in FIG. 5A, then the intersections of all three of the planes of standing electromagnetic wave electric field nodes have the minimum electric field intensities. After applying the three standing electromagnetic waves to the monocrystal silicon sample uniformly doped with Li⁷ atoms 21 for 30 days, the density of Li⁷ atoms 22 in the intersections previously described, increase significantly above 10¹⁴ Lie atoms per cm³. As a result, a dot, spot, or cluster containing a high density of Li⁷ atoms 110 is formed in FIG. 5C. The final form of the monocrystal silicon sample uniformly doped with Li⁷ atoms 21 is the monocrystal silicon sample containing dots, spots, or clusters of Li⁷ atoms 112 as shown in FIG. 5C. The temperature of monocrystal silicon sample containing dots, spots, or clusters of Li⁷ atoms 112 is 170° K and its dimensions are 1 mm×1 mm×1 mm in FIG. 5C.

### OPERATION—FIGS. 2, 4

I. Secure monocrystal silicon sample uniformly doped with Li⁷ atoms 21 to support fixture 92. The monocrystal silicon sample uniformly doped with Li⁷ atoms 21 is a 15.24 cm (6 inch) diameter wafer with the sample thickness 45 of 1 mm. This wafer is sawed from a 15.24 cm (6 inch) diameter silicon single crystal ingot doped with 10¹⁴ Li⁷ atoms per cm³. The saw used is a diamond-tipped inner-hole blade saw. The sample is then mechanically lapped and ground on both sides to obtain a flat surface. To give the sample a mirror like finish it is polished using a slurry of fine SiO₂ particles in basic NaOH solution.

II. Seal the vacuum chamber 96 and using the vacuum pump 98 pump gas out of the vacuum chamber until a vacuum chamber pressure of 1 torr is obtained. Maintain this pressure using the vacuum pump as needed.

III. Provide power to the quantum cascade laser 76 and fine tune it to the frequency 1.56×10¹³ Hz.

IV. Adjust parts 78, 80, 82, 84, 86, 88, and 92 as needed such that a standing electromagnetic wave exists within the monocrystal silicon sample uniformly doped with Li⁷ atoms 21 as described in FIGS. 2A and 2B. The electromagnetic waves 44a and 44b beam spot diameter on the surface of the monocrystal silicon sample uniformly doped with Li⁷ atoms 21 should be 10.16 cm (4 inches) and have a power between 60 mW and 40 mW.

V. After 30 days of powering the quantum cascade laser 76, shut it down.

VI. Turn off vacuum pump 98 and allow vacuum chamber 96 pressure to rise to room pressure, which is 760 torr.

VII. Open vacuum chamber, remove the monocrystal silicon sample containing planes of Li⁷ atoms 57 from the vacuum chamber and maintain the monocrystal silicon sample containing planes of Li⁷ atoms 57 at the temperature 170° K.

### CONCLUSION, RAMIFICATIONS, AND SCOPE

Accordingly, the reader will see that the method for forming periodic electronic potential structures in bulk solids using standing electromagnetic waves of this invention can be used to form a variety of electronic potential structures. Forming each layer of a periodic graded chemical composition simultaneously is more time efficient than forming it one layer at a time. In addition, using the method of this invention results in electronic potential structures that are identical and equally spaced from on another. Furthermore, the electronic potential structures formed by the method of this invention can be altered or recycled to form new electronic potential structures.

While the above description contains many specificities, these should not be construed as limitations on the scope of the invention, but rather as an exemplification of one preferred embodiment thereof Many other variations are possible. For example:
The monocrystal silicon sample uniformly doped with Li⁷ atoms can be another type of semiconductor doped with another type of dopant and the dopant density is not limited to 10¹⁴ atoms per cm³. However, changing the semiconductor and dopant changes the local vibration mode frequency so the electromagnetic wave's frequency must be changed to match that of the local vibration mode frequency. There are numerous semiconductors, insulators, and dopants that can be used.
The monocrystal silicon sample does not have to be a monocrystal. The monocrystal silicon sample can be amorphous or polycrystalline however the best uniformity and spacing of the electronic potential structure created by the standing electromagnetic wave is achieved if the monocrystal silicon sample is a monocrystal.
The sample thickness is not restricted to 1 mm. The lower the monocrystal silicon sample absorption coefficient, the greater the sample thickness can be without significantly reducing the quality of the standing electromagnetic wave.
The temperature of 170° K in which the monocrystal silicon sample containing planes of Li⁷ atoms, the monocrystal silicon sample containing rows or wires of Li⁷ atoms, and the monocrystal silicon sample containing dots, spots, or clusters of Li⁷ atoms is maintained at is somewhat arbitrary. In general the lower the temperature of a closely spaced electronic potential structure, the longer it will last or maintain its physical properties.
The shape of the reflectors, the shape of the electromagnetic wave front, and the shape of the surfaces of the monocrystal silicon sample are not limited to planar. Whatever the shape, the resultant standing electromagnetic wave dictates the shape and form of the regions of high dopant atom densities and regions of low dopant atom densities in the monocrystal silicon sample.
Besides crossing two electromagnetic waves to form a standing electromagnetic wave, two other ways of doing this are: reflecting an electromagnetic wave from an external reflector so that the reflected electromagnetic wave overlaps the incoming electromagnetic wave, and encasing an active electromagnetic wave source in an optical resonator or cavity. In either of these cases the beam splitter is not required.
More than one electromagnetic wave source, and/or beamsplitter, and/or reflector, and/or other optical components may be used to create a multitude of standing electromagnetic waves of various wave front shapes and sizes.
The variable actuator, spatial light filter, convex lens, and iris, are not necessary however, these parts tend to improve the quality of and provide control of the area of the electronic potential structures produced in the monocrystal silicon sample. Other optical components can be used for these purposes such as replacing the convex lens with a fresnel lens.
The vacuum chamber and vacuum pump are not necessary unless the gas in the environment in which this process is taking place, has a high absorption coefficient for the electromagnetic wave frequency in use. If the gas absorption coefficient is low, the vacuum chamber and vacuum pump can still improve the quality of the quantum structures produced by eliminating electromagnetic beam disruptions caused by gas turbulence. However, other methods for eliminating gas turbulence can be used if the environment gas absorption coefficient is low, such as hollow cylinders in which the electromagnetic wave may propagate in unaffected.
The vacuum pump is not needed if the vacuum chamber is cooled using a heat sink to a low enough temperate such that the gas inside the vacuum chamber becomes or low or becomes a liquid or solid.
The electromagnetic wave source does not have to be a quantum cascade laser. Any coherent light source that can provide the required local vibration mode frequency can be used.
The electromagnetic wave beam diameter and power of the electromagnetic wave are not restricted to 10.16 cm (4 inches) and between 60 and 40 milliwatts, respectively. The selection of these values depends on the type of semiconductor, dopant, sample dimensions, and absorption coefficient.
If the standing electromagnetic wave is produced by the beam splitter and reflectors as shown in FIG. 4 then the constant wave output produced by the quantum cascade laser can be replaced with a pulsed wave output if the optical path length of the two electromagnetic waves 44a and 44b are equal as measured from the beam splitter interface to the center of the monocrystal silicon sample, and the length of the electromagnetic wave pulse is significantly larger than the sample thickness.
The time of 30 days in which the standing electromagnetic wave existed within monocrystal silicon sample is somewhat arbitrary. In general, the longer this time, the greater the quality of the electronic potential structures produced in the monocrystal silicon sample.
The monocrystal silicon sample can be doped with more than one type of dopant so a multitude of planes of high dopant atom densities and planes of low dopant atom densities can be created from different dopant atoms. Each dopant would have its own local vibration mode frequency in the monocrystal silicon sample, thus a standing electromagnetic wave of a particular frequency would be needed for each type of dopant.

The geometry of the regions containing high dopant atom densities is not limited to planes, rows or wires, and dots, clusters or spots. Other geometry's are possible using various optical components. A few potential geometry's are circles, spheres, cylinders, crisscross, zigzag, and checkered given the correct electromagnetic standing wave front shape.

Accordingly, the scope of the invention should be determined not by the embodiments illustrated, but by the appended claims and their legal equivalents.

1. A method for forming a structure in a state of matter, comprising the step of:
a establishing a standing electromagnetic wave in said state of matter.

2. A method for forming a graded dopant or impurity density in a state of matter, comprising the step of:
a. establishing a standing electromagnetic wave in said state of matter.

3. A method for forming a graded mass density in a state of matter, comprising the step of:
a. establishing a standing electromagnetic wave in said state of matter.
